(19) United States
(12) Patent Application Publication
(10) Pub. No.: US 2009/0317656 A1
(43) Pub. Date: Dec. 24, 2009

(54) Aluminum alloy article with micro-arc oxide for film and method for making the same

(75) Inventors: Feng-Yuen Dai, Shindian (TW); Yung-Ta Lo, Shindian (TW); Jing Han, Shenzhen (CN); Bao-Shen Zhang, Shenzhen (CN); Wei Liu, Shenzhen (CN); Yong Qiao, Shenzhen (CN); Qi-Qi Yan, Shenzhen (CN); Chi-Chuang Ho, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION TECHNOLOGY INDUSTRY CO., LTD., ShenZhen City (CN); FHI (HONG KONG) LIMITED, Hong Kong (CN)

(21) Appl. No.: 12/456,572

(22) Filed: Jun. 18, 2009

(30) Foreign Application Priority Data
Jun. 19, 2008 (CN) 200810302204.5

(51) Int. Cl. B32B 5/14; C25D 5/18

(52) U.S. Cl. 428/610; 205/107

(57) ABSTRACT

An aluminum alloy article includes an aluminum alloy substrate and a micro-arc oxide film formed on the aluminum alloy substrate. The micro-arc oxide film includes a transition layer gradually infiltrating into the aluminum alloy substrate, a middle dense layer formed on the transition layer, and an outer dense layer formed on the middle dense layer, the outer dense layer having a density larger than that of the middle dense layer.

### BACKGROUND

1. Technical Field

The present disclosure relates to aluminum alloy articles and, particularly, to an aluminum alloy article with micro-arc oxide film and a method for making the same.

2. Description of Related Art

Aluminum alloy articles are widely used in construction, automotives, aviation, and consumer electronics industries, because they are lightweight, easy to manufacture, and possess many good mechanical characteristics. However, aluminum alloy articles have low rigidity and corrode easily. Thus, a surface treatment process is necessarily applied to the aluminum alloy articles to form an oxide film covering the surfaces of the aluminum alloy articles.

Micro-arc oxidation is an effective surface treatment process to strengthen and protect the surfaces of the aluminum alloy articles. During the micro-arc oxidation, a ceramic oxide film is formed on the surfaces of the aluminum alloy articles. The ceramic oxide film typically includes three layers consisting of an inner transitional layer, a middle compact layer, and an outer loose layer. The outer loose layer defines many micro pores which corrosive materials may penetrate into, thereby reducing anti-corrosion ability of the ceramic oxide film. To improve the performance of the ceramic oxide film, the outer loose layer is typically removed from the ceramic oxide film by polishing. However, the polishing may damage micro structures of the middle compact layer, thereby reducing anti-abrasion characteristics of the ceramic oxide film.

Therefore, there is room for improvement within the art.

### BRIEF DESCRIPTION OF THE DRAWINGS

Many aspects of the aluminum alloy article can be better understood with reference to the following drawings. The components in the drawings are not necessarily to scale, the emphasis instead being placed upon clearly illustrating the principles of the present aluminum alloy article. Moreover, in the drawing, like reference numerals designate corresponding parts throughout the following view.

FIG. 1 is a scanning electron microscope image of a cross section of an exemplary embodiment of the present aluminum alloy article.

FIG. 2 is a flow chart of an exemplary embodiment of a method for making the present aluminum alloy article shown in FIG. 1.

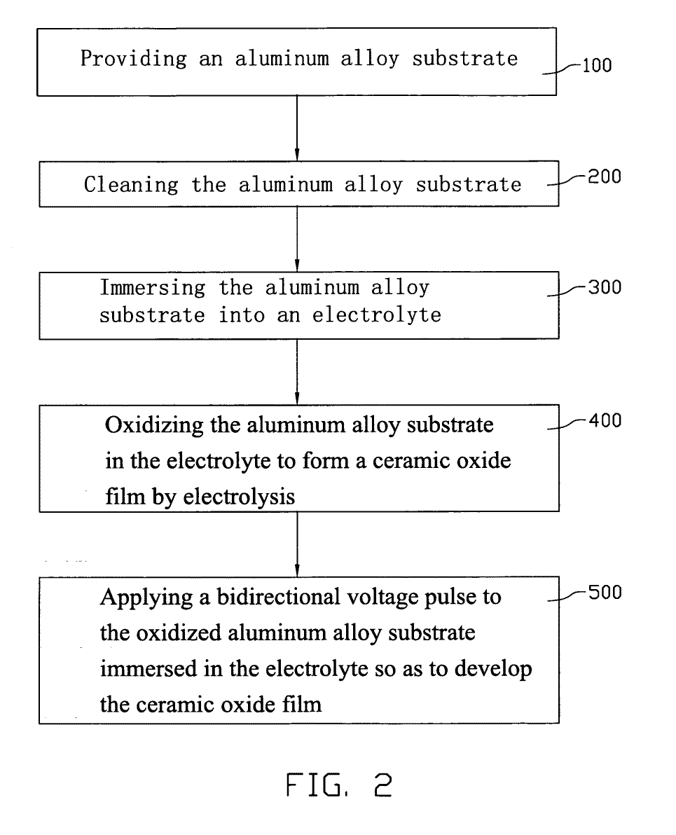

### DETAILED DESCRIPTION

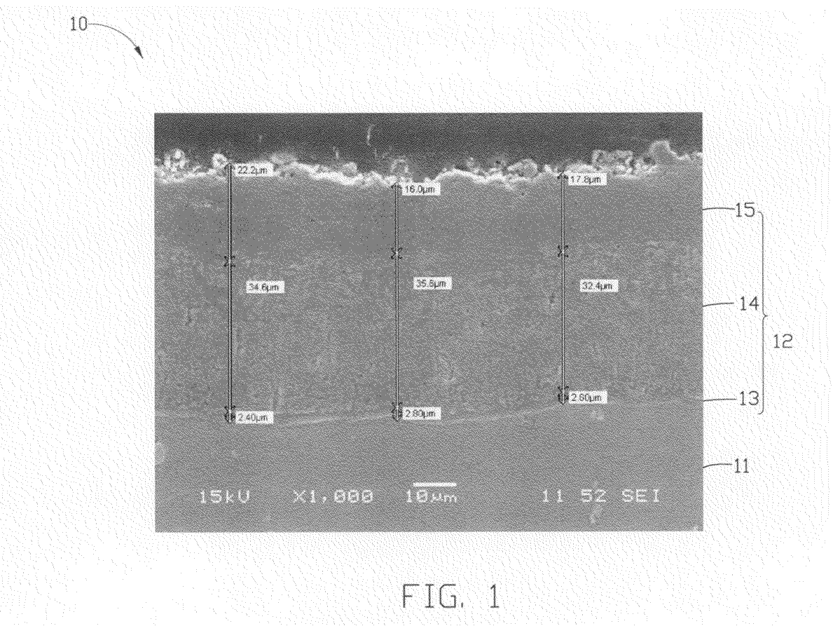

Referring to the FIG. 1, the aluminum alloy article 10 includes an aluminum alloy substrate 11 and a micro-arc oxide film 12 formed on the aluminum alloy substrate 11. The micro-arc oxide film 11 includes a transition layer 13 gradually infiltrating into the aluminum alloy substrate 11, a middle dense layer 14 formed on the transition layer 13, and an outer dense layer 15 formed on the middle dense layer 14.

The micro-arc oxide film 12 includes alpha aluminum oxide (α-Al₂O₃) as its main component. The micro-arc oxide film 12 has a thickness in a range from about 30 to about 150 micro meters and a rigidity in a range from about 500 to about 2800 HV (Vickers Hardness).

The transition layer 13 has a thickness in a range from about 4 to about 7 percent of the thickness of the micro-arc oxide film 12. The micro-arc oxide film 12 and the aluminum alloy substrate 11 partially and gradually interpenetrate each other at the transition layer 13, thereby improving attachment between the micro-arc oxide film 12 and the aluminum alloy substrate 11.

The middle dense layer 14 has a thickness in a range from about 50 to about 70 percent of the thickness of the micro-arc oxide film 12. The middle dense layer 14 defines a plurality of micro blind holes.

The outer dense layer 15 has a thickness in a range from about 24 to about 45 percent of the thickness of the micro-arc oxide film 12. The outer dense layer 15 has a density larger than that of the middle dense layer 14. Porosity of the outer dense layer 15 is also less than that of the middle dense layer 14.

An exemplary method for making the aluminum alloy article 10 includes steps 100 to 500.

In step 100, an aluminum alloy substrate 11 is provided.

In step 200, the aluminum alloy substrate 11 is cleaned. During the cleaning process, the aluminum alloy substrate 11 is firstly immersed in an alkali solution for about 10 minutes and then rinsed in water.

In step 300, the cleaned aluminum alloy substrate 11 is then immersed into an electrolyte including at least one of phosphate salt, borate salt, silicate salt, aluminate salt, and alkali metal hydroxide. The phosphate salt can be one of sodium hexa meta phosphate at a concentration of about 5.0 to about 25.0 g/l (gram per liter), sodium tri-poly phosphate at a concentration of about 5.0 to about 25.0 g/l, and sodium dihydrogen phosphate at a concentration of about 30.0 to about 80.0 g/l. The borate salt can be sodium tetra borate at a concentration of about 0.1 to about 5.0 g/l. The silicate salt can be sodium silicate at a concentration of about 2.0 to about 10.0 g/l. The aluminate salt can be sodium aluminate at a concentration of about 2.0 to about 10.0 g/l. The alkali metal hydroxide can be one of sodium hydroxide at a concentration of about 0.5 to about 4.0 g/l and potassium hydroxide at a concentration of about 0.5 to about 4.0 g/l. The electrolyte may further include at least one of sodium tungstate at a concentration of about 2.0 to about 5.0 g/l, sodium meta vanadate at a concentration of about 15.0 to about 30.0 g/l, ammonium meta vanadate at a concentration of about 15.0 to about 30.0 g/l, copper sulfate at a concentration of about 0.5 to about 10.0 g/l, cobalt sulfate at a concentration of about 0.1 to about 1.5 g/l, sodium fluoride at a concentration of about 20.0 to about 30.0 g/l, cobalt acetic at a concentration of about 0.1 to about 1.5 g/l, sorbitol at a concentration of about 0.5 to about 6.0 g/l, and glycerol at a concentration of about 0.5 to about 6.0 g/l. The pH of the electrolyte should be in a range from about 10.5 to about 12.5.

In step 400, the aluminum alloy substrate 11 is oxidized in the electrolyte to form a ceramic oxide film by electrolysis. During the oxidization, a forward voltage is applied to the aluminum alloy substrate 11 through an anode immersed in the electrolyte using a current density in a range from about 2 to about 20 amperes per square decimeter, at a temperature in a range from about 20° C. to about 50° C. for about 1 to about 5 minutes. As the oxidization proceeds, the ceramic oxide film including a transition layer, a middle dense layer, and a loose layer, grows on the aluminum alloy substrate 11.

In step 500, a bidirectional voltage pulse including a forward pulse and a reverse pulse is applied to the oxidized aluminum alloy substrate 11 while it is immersed in the electrolyte for about 30 to about 180 minutes at a temperature of about 20° C. to about 50° C. so as to develop the ceramic oxide film. The pulse width of the bidirectional pulse is about 1000 to about 10000 microseconds. The pulse interval of the bidirectional pulse is about 300 to about 2000 microseconds. During the reverse pulse being applied to the oxidized aluminum alloy substrate 11, the voltage gradually grows to a negative voltage in a range from about −30 to about −200 volts. Thus, the oxidized aluminum alloy substrate 11 functions as a cathode. A surface layer of the ceramic oxide film may be reduced and dissolved. That is, the electrolyte penetrates into the loose layer of the ceramic oxide film, thereby reducing and dissolving the loose layer of the ceramic oxide film. During the forward pulse being applied to the oxidized aluminum alloy substrate 11, the voltage gradually grows to a positive voltage in a range from about 450 to about 650 volts, and the ceramic oxide film grows more, thereby forming an outer dense layer on the middle dense layer.

As such, during application of the bidirectional voltage pulse to the oxidized aluminum alloy substrate 11, the outer dense layer grows periodically and the loose layer is dissolved during alternate periods.

In a first example according to the above disclosure, the aluminum alloy substrate 11 is made of alloy type 1060. The electrolyte contains potassium hydroxide at a concentration of about 1.0 grams per liter and sodium silicate at a concentration of about 2.0 grams per liter. During the step 400, the current density is about 5 amperes per square decimeter, the temperature of the electrolyte is about 20° C., and the time that the oxidization proceeds is about 1 minutes. During the step 500, the positive voltage is about 500 volts, the negative voltage is about 60 volts, the pulse width is about 1000 microseconds, the pulse interval is about 300 microseconds, and the time that the bidirectional pulse proceeds is about 60 minutes. The thickness of the ceramic oxide film obtained according to the first example is in a range from about 30 to about 35 micrometers, wherein the thickness of the middle dense layer is about 18 micrometers, and the thickness of the outer dense layer is about 10 micrometers. The ceramic oxide film presents grayish.

In a second example according to the above disclosure, the aluminum alloy substrate 11 is made of alloy type 2017. The electrolyte contains sodium hydroxide at a concentration of about 2.0 grams per liter, sodium fluoride at a concentration of about 20.0 grams per liter, and sodium aluminate at a concentration of about 2.0 grams per liter. During the step 400, the current density is about 6 amperes per square decimeter, the temperature of the electrolyte is about 20° C., and the time that the oxidization proceeds is about 2 minutes. During the step 500, the positive voltage is about 550 volts, the negative voltage is about 90 volts, the pulse width is about 2000 microseconds, the pulse interval is about 500 microseconds, and the time that the bidirectional pulse proceeds is about 90 minutes. The thickness of the ceramic oxide film obtained according to the first example is in a range from about 53 to about 60 micrometers, wherein the thickness of the middle dense layer is about 32 micrometers, and the thickness of the outer dense layer is about 21 micrometers. The ceramic oxide film presents black.

In a third example according to the above disclosure, the aluminum alloy substrate 11 is made of alloy type LY12. The electrolyte contains sodium hydroxide at a concentration of 2.0 grams per liter, sodium tetra borate at a concentration of 1.0 grams per liter, sodium tungstate at a concentration of 2.0 grams per liter, and glycerol at a concentration of 2.0 grams per liter. During the step 400, the current density is about 7 amperes per square decimeter, the temperature of the electrolyte is about 30° C., and the time that the oxidization proceeds is about 2 minutes. During the step 500, the positive voltage is about 550 volts, the negative voltage is about 120 volts, the pulse width is about 3000 microseconds, the pulse interval is about 1000 microseconds, and the time that the bidirectional pulse proceeds is about 100 minutes. The thickness of the ceramic oxide film obtained according to the first example is in a range from about 65 to about 70 micrometers, wherein the thickness of the middle dense layer is about 40 micrometers, and the thickness of the outer dense layer is about 25 micrometers. The ceramic oxide film presents nut-brown.

In a fourth example according to the above disclosure, the aluminum alloy substrate 11 is made of alloy type 5052. The electrolyte contains sodium hexa meta phosphate at a concentration of 25.0 grams per liter, sodium tri-poly phosphate at a concentration of 25.0 grams per liter, ammonium meta vanadate at a concentration of 15.0 grams per liter, glycerol at a concentration of about 2.0 g/l, and sodium silicate at a concentration of 2.0 grams per liter. During the step 400, the current density is about 8 amperes per square decimeter, the temperature of the electrolyte is about 20° C., and the time that the oxidization proceeds is about 3 minutes. During the step 500, the positive voltage is about 450 volts, the negative voltage is about 60 volts, the pulse width is about 3000 microseconds, the pulse interval is about 1000 microseconds, and the time that the bidirectional pulse proceeds is about 35 minutes. The thickness of the ceramic oxide film obtained according to the first example is in a range from about 32 to about 35 micrometers, wherein the thickness of the middle dense layer is about 20 micrometers, and the thickness of the outer dense layer is about 12 micrometers. The ceramic oxide film presents tan.

In a fifth example according to the above disclosure, the aluminum alloy substrate 11 is made alloy type 7075. The electrolyte contains potassium hydroxide at a concentration of 1.0 grams per liter, sodium tetra borate at a concentration of 1.0 grams per liter, and sodium silicate at a concentration of 2.0 grams per liter. During the step 400, the current density is about 10 amperes per square decimeter, the temperature of the electrolyte is about 20° C., and the time that the oxidization proceeds is about 5 minutes. During the step 500, the positive voltage is about 600 volts, the negative voltage is about 150 volts, the pulse width is about 3000 microseconds, the pulse interval is about 300 microseconds, and the time that the bidirectional pulse proceeds is about 30 minutes. The thickness of the ceramic oxide film obtained according to the first example is in a range from about 82 to about 90 micrometers, wherein the thickness of the middle dense layer is about 50 micrometers, and the thickness of the outer dense layer is about 32 micrometers. The ceramic oxide film presents tan.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An aluminum alloy article, comprising:
an aluminum alloy substrate;
and a micro-arc oxide film formed on the aluminum alloy substrate, the micro-arc oxide film comprising:
a transition layer gradually infiltrating into the aluminum alloy substrate;
a middle dense layer formed on the transition layer;
and an outer dense layer formed on the middle dense layer, the outer dense layer having a density larger than that of the middle dense layer.

2. The aluminum alloy article as claimed in claim 1, wherein a porosity of the outer dense layer is also less than that of the middle dense layer.

3. The aluminum alloy article as claimed in claim 1, wherein the micro-arc oxide film has a thickness in a range from about 30 to about 150 micro meters.

4. The aluminum alloy article as claimed in claim 1, wherein the micro-arc oxide film has a rigidity in a range from about 500 to about 2800 HV.

5. The aluminum alloy article as claimed in claim 1, wherein the transition layer has a thickness in a range from about 4 to about 7 percent of that of the micro-arc oxide film.

6. The aluminum alloy article as claimed in claim 1, wherein the middle dense layer has a thickness in a range from about 50 to about 70 percent of that of the micro-arc oxide film.

7. The aluminum alloy article as claimed in claim 1, wherein the outer dense layer has a thickness in a range from about 24 to about 45 percent of that of the micro-arc oxide film.

8. A method for making an aluminum alloy article, comprising:
providing an aluminum alloy substrate;
immersing the aluminum alloy substrate into an electrolyte;
oxidizing the aluminum alloy substrate in the electrolyte to form a ceramic oxide film by electrolysis; and
applying a bidirectional voltage pulse to the oxidized aluminum alloy substrate immersed in the electrolyte so as to develop the ceramic oxide film.

9. The method as claimed in claim 8, wherein the electrolyte includes at least one of phosphate salt, borate salt, silicate salt, aluminate salt, and alkali metal hydroxide.

10. The method as claimed in claim 8, wherein the electrolyte further includes at least one of sodium tungstate at a concentration of about 2.0 to about 5.0 g/l, sodium meta vanadate at a concentration of about 15.0 to about 30.0 g/l, ammonium meta vanadate at a concentration of about 15.0 to about 30.0 g/l, copper sulfate at a concentration of about 0.5 to about 10.0 g/l, cobalt sulfate at a concentration of about 0.1 to about 1.5 g/l, sodium fluoride at a concentration of about 20.0 to about 30.0 g/l, cobalt acetic at a concentration of about 0.1 to about 1.5 g/l, sorbitol at a concentration of about 0.5 to about 6.0 g/l, and glycerol at a concentration of about 0.5 to about 6.0 g/l.

11. The method as claimed in claim 8, wherein the phosphate salt is one of sodium hexa meta phosphate at a concentration of about 5.0 to about 25.0 g/l, sodium tri-poly phosphate at a concentration of about 5.0 to about 25.0 g/l, and sodium dihydrogen phosphate at a concentration of about 30.0 to about 80.0 g/l.

12. The method as claimed in claim 8, wherein the borate salt is sodium tetra borate at a concentration of about 0.1 to about 5.0 g/l.

13. The method as claimed in claim 8, wherein pH scale of the electrolyte is in a range from 10.5 to about 12.5.

14. The method as claimed in claim 8, wherein during oxidizing the aluminum alloy substrate in the electrolyte by electrolysis, a forward voltage is applied to the aluminum alloy substrate as an anode immersed in the electrolyte using a current density in a range from about 2 to about 20 amperes per square decimeter, at a temperature in a range from 20° C. to about 50° C. for 1 to about 5 minutes.

15. The method as claimed in claim 8, wherein the bidirectional pulse of voltage includes a forward pulse in a range from 450 to about 650 volts and a reverse pulse in a range from −30 to about −200 volts.

16. The method as claimed in claim 15, wherein during the reverse pulse being applied to the oxidized aluminum alloy substrate, a surface layer of the ceramic oxide film is reduced and dissolved.

17. The method as claimed in claim 15, wherein during the forward pulse being applied to the oxidized aluminum alloy substrate, the ceramic oxide film grows.

18. The method as claimed in claim 8, wherein the bidirectional pulse has a pulse width of about 1000 to about 10000 microseconds and a pulse interval of about 300 to about 2000 microseconds.
